(19) United States
(12) Patent Application Publication
(10) Pub. No.: US 2015/0042640 A1
(43) Pub. Date: Feb. 12, 2015

(54) FLOATING 3D IMAGE IN MIDAIR

(71) Applicant: Cherif Atia Algreatly, Newark, CA (US)

(72) Inventor: Cherif Atia Algreatly, Newark, CA (US)

(73) Assignee: Cherif Atia Algreatly, Newark, CA (US)

(21) Appl. No.: 13/961,025

(22) Filed: Aug. 7, 2013

(51) Int. Cl. G06T 15/10

(52) U.S. Cl. CPC G06T 15/10
USPC 345/419

(57) ABSTRACT

A first method is disclosed for projecting an image on random surfaces from a movable projection source to give the image the appearance of a floating three-dimensional image relative to a point of view. A second method is also disclosed for projecting a virtual 3D model on a 3D environment wherein certain virtual objects of the virtual 3D model are projected on certain actual objects of the 3D environment while the source of projecting the virtual 3D model is moving. A third method is disclosed for projecting an image on a transparent surface that can be held by a user's hands wherein the content of the image suits the identity of the objects located behind the transparent surface relative to a point of view.

### CROSS-REFERENCE TO RELATED APPLICATION

This application is a Continuation-in-Part of co-pending U.S. Patent Applications No. 61/624,174, filed Aug. 8, 2012, titled “Method, system, and device for displaying digital data”, and No. 61/743,022, filed Aug. 23, 2013, titled “Method and system for projecting images using 3-D scanning”.

### BACKGROUND

Projecting floating 3D images in midair can dramatically replace the traditional mediums of displaying digital data. The current available traditional mediums for displaying digital data, such as computer screens, holograms, and projectors have major disadvantages in comparison with the idea of floating 3D images. For example, computer screens constrain users from motion when viewing the digital data presented on the screen. This contrasts with the idea of floating 3D images that follow the user's movement to display the digital data in front of him/her, regardless of the user's location or body position.

Viewing holograms requires the user to look at or through a piece of glass or film to see the image, if a “mid-air” effect is intended the hologram image appears slightly in front of or behind a glass. Accordingly, holograms are best suited for museum-type applications while floating 3D images are supposed to be used anywhere without the need for glass or film to display the digital data. Projectors require a flat wall or surface when projecting the digital data, as well as, specific space dimensions and certain sitting positions to view the projected images. This contrasts with the idea of floating 3D images, which does not require a flat surface, or particular space dimensions or sitting positions.

In fact, until now there has not been a universal method or technique which achieves the idea of projecting 3D images floating-in-midair. Once this method or technique is invented, it is expected to replace most traditional mediums of displaying digital data and to open the door for innovative entertainment, gaming, educational, engineering, and industrial applications.

### SUMMARY

The present invention introduces a method and system for projecting 3D images floating-in-midair. In this case, the 3D images are always located in front of the user's eyes even when s/he walks, turns around, or lies supine. The user can move around the 3D objects presented in the 3D images or even walk through these 3D objects to see more details or scenes from different points of view. The user can interact with the content of the 3D images similar to the way s/he interacts with a content presented on a computer display. The content of the 3D image may include 3D models, images, videos, text, or the like.

In one embodiment, the present invention discloses a method for projecting an image to appear as a floating 3D image in midair relative to a user's point of view. Changing the position of the user while walking simultaneously changes the projection of the image to appear as if it is always located in front of the user, or to appear as if it has a fixed position regardless of the user's position or movement. The projection of the image is generated by a head mounted projector utilized by the user a 3D scanner is also utilized to detect the locations and shapes of the surfaces located in front of the projector. A CPU receives the data of the 3D scanner and changes the parameters of the image to be projected. The change of the image parameters makes the projected image appears as if it is floating in mid-air, regardless of the locations and shapes of the surfaces located in front of the projector. In another embodiment, the use of the 3D scanner is replaced with a database that stores a 3D model for the surfaces located in front or around the user essentially storing a 3D model of the surfaces instead of creating the 3D model of the surfaces in real time using a 3D scanner.

In one embodiment, the present invention discloses a method for projecting virtual objects on certain real objects in front of a user. For example, projecting an image of a man on a door, regardless of the user's movement with the head mounted projector, to make the man appear as he is standing in front of the door relative to the user even when the user moves. Also, projecting an image of a virtual 3D home on the interior walls of a real home where the doors and windows of the virtual 3D home are always projected on top of the doors or windows of the real home, regardless of the user's head mounted projector movement. This is achieved by identifying the real objects located in front of the user and also identifying the virtual objects located in a 3D model and then changing the locations of the virtual object in the 3D model so it is projected on top of the real objects in front of the user during the user's movement.

In another embodiment, the present invention discloses a system for projecting an image on a transparent surface held by the user's hands wherein the projected image include virtual objects with certain parameters that suit the identities and locations of real objects located behind the transparent surface. In one embodiment, the image is partially projected on the transparent surface while the rest of the image is projected on the real objects located behind the transparent surface. The partial images projected on both of the transparent surface and the real objects form a complete image relative to the user's point of view as will be described subsequently.

### BRIEF DESCRIPTION OF DRAWINGS

FIG. 1 illustrates three images projected on three surfaces located at different positions to form one rectangular virtual screen relative to a point of view.

FIG. 2 illustrates a top view for the projection of the three images where the different positions of the three surfaces appear in the figure.

FIG. 3 illustrates the difference dimensions or sizes of the three images relative to each other.

FIG. 4 illustrates the three images forming one virtual screen relative to the point of view.

FIG. 5 illustrates a top view for four images projected on four surfaces located at different positions.

FIG. 6 illustrates projecting ten images on ten surfaces located at different positions to form one virtual screen relative to a point of view.

FIG. 7 illustrates projecting four images on a sphere, cylinder, cube, and flat surface to form one virtual screen relative to a point of view.

FIG. 8 illustrates simultaneously changing the shape of a virtual screen with a shift of a point of view so the virtual screen appears as if it has a fixed position.

FIG. 9 illustrates a virtual screen projected on four surfaces to look like a sloped window relative to a point of view.

FIG. 10 illustrates a virtual screen in the form of six pages of a book projected on five surfaces.

FIGS. 11 to 15 illustrate a virtual screen in the form of a virtual cube projected on three faces of a cube.

FIG. 16 illustrates a virtual screen containing an image of a person projected on a window to make the person appears as if he is standing behind the window.

FIGS. 17 to 18 illustrate a virtual screen projected on a table to present the hidden edges of the table with dotted lines.

FIG. 19 illustrates a virtual screen projected on a chair, floor, and wall to present a person sitting on the chair.

FIG. 20 illustrates a person sleeping on a pillow where a virtual screen is projected on the person's forehead presenting a medical image of the person's brain.

FIG. 21 illustrates a virtual 3D model of a home projected on walls where a user can walk through the virtual 3D model.

FIG. 22 illustrates a block diagram for the main components of the present invention according to one embodiment.

FIG. 23 illustrates another block diagram for the main components of the present invention according to another embodiment.

FIG. 24 illustrates a device comprised of a 3D scanner, projector, CPU, and memory unit according to one embodiment of the present invention.

FIG. 25 illustrates a virtual screen projected on a portable transparent surface showing Mickey Mouse entering from a door located in front of a user.

FIG. 26 illustrates the same virtual screen partially projected on the portable transparent surface and the walls located in front of the user.

FIG. 27 illustrates a virtual screen projected on a first wall, a second wall, a third wall, and a fourth wall.

FIG. 28 illustrates the first part, the second part, the third part, and the fourth part of the virtual screen projected on the four walls.

FIG. 29 illustrates the dimensions or shapes of the four parts of the virtual screen projected on the four walls.

FIG. 30 illustrates a top view of the projection of the four parts of the virtual screen on the four walls.

FIG. 31 illustrates a side view of the projection of the four parts of the virtual screen on the four walls.

### DETAILED DESCRIPTION OF INVENTION

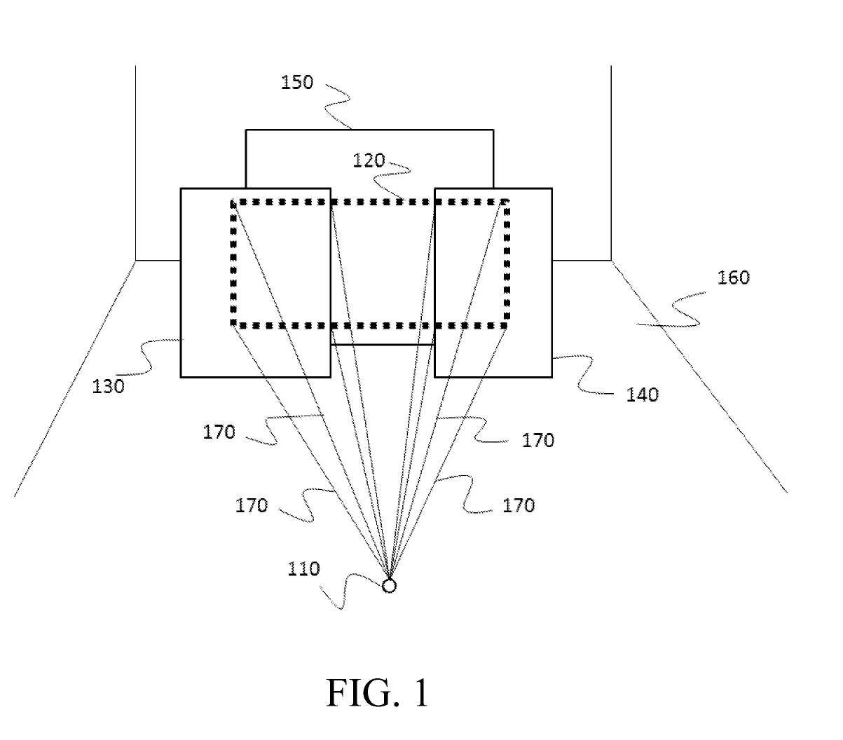

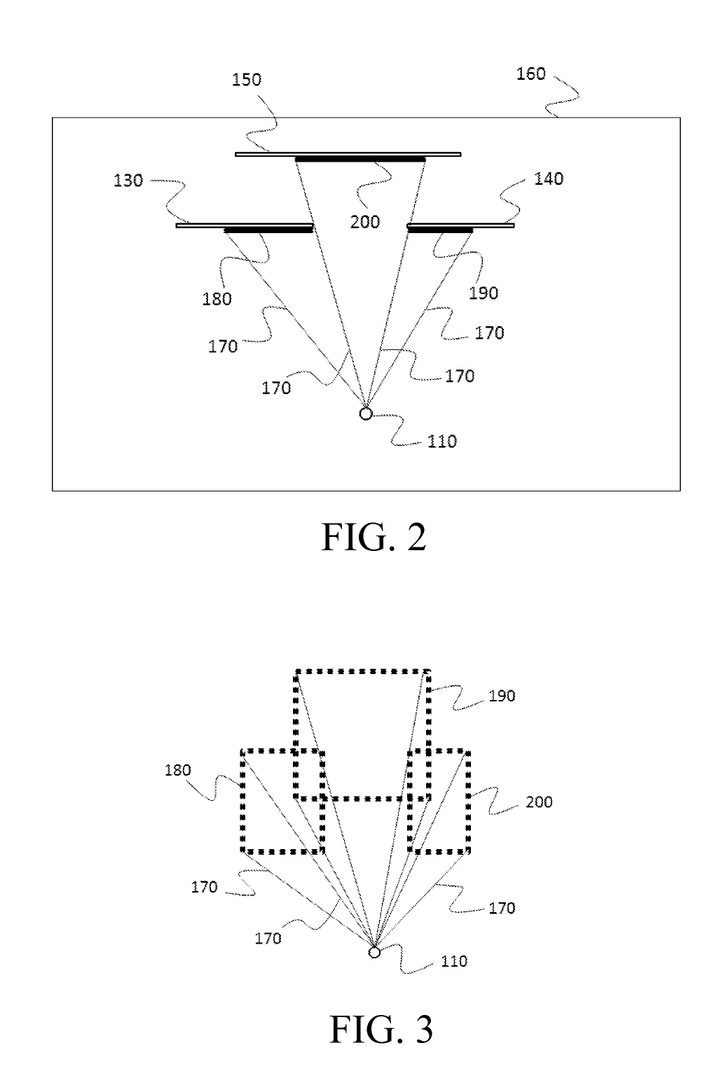

FIG. 1 illustrates the point of view 110 of a user looking at a virtual screen 120 projected from a head mounted projector utilized by the user. The virtual screen is projected on a first surface 130, a second surface 140, and a third surface 150 that are located at different positions inside a room 160. The lines 170 represent eight rays extending from the point of view to the corners of the projected image or the virtual screen on each one of the three surfaces. FIG. 2 illustrates a top view of the point of view 110, the first surface 130, the second surface 140, the third surface 150, the room 160, and the rays 170. As shown in the figure, the rays that connect the point of view and the corners of the virtual screen to the three surfaces divide the virtual screen into a first part 180, a second part 190, and a third part 200. The three parts of the virtual screen form one rectangular virtual screen relative to the point of view as illustrated in FIG. 1.

The third surface is located further away from the head mounted projector than the first surface and the second surface, and accordingly, if the virtual screen is projected as one rectangular image then the first, second, and third parts of the virtual screen will not appear to the point of view as one unit or rectangle. To correct this, the shape of the second part of the virtual screen is adjusted to suit its location relative to the first part and second part of the virtual screen. Generally, adjusting the second part of the virtual screen depends on the locations of each of the three surfaces relative to the point of view. If the three surfaces are flat surfaces then each surface is represented by the Cartesian coordinates of its corners. If a surface is comprised of a plurality of flat surfaces then this surface is represented by the Cartesian coordinates of the corners of each one of the plurality of the flat surfaces. If a surface is a curved surface, such as a sphere or a cylinder, then the type of the surface curvature is determined and taken into consideration when projecting the virtual screen.

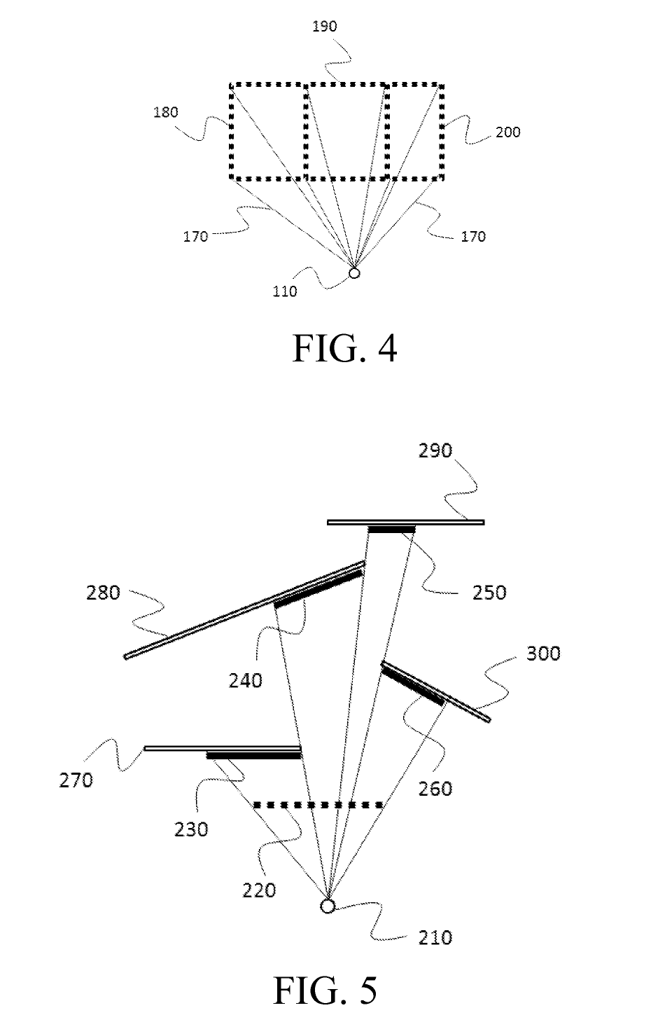

FIG. 3 illustrates adjusting the dimensions or shape of the first part 180, the second part 190, and the third part 200 of the virtual screen according to the positions of their surfaces relative to the point of view. FIG. 4 illustrates the first, second, and third parts forming one rectangular image of a virtual screen when they are seen from the point of view. This is achieved by changing the dimensions or shape of each part of the projected image according to position of the surface that the part of the virtual screen is projected on it. Changing the position of the point of view during the user's movement leads to changing the surfaces in front of the head mounted projector that the virtual screen is projected on. Accordingly, the parts and parameters of the virtual screen are simultaneously changing when projected on surfaces to appear as one virtual screen relative to the point of view.

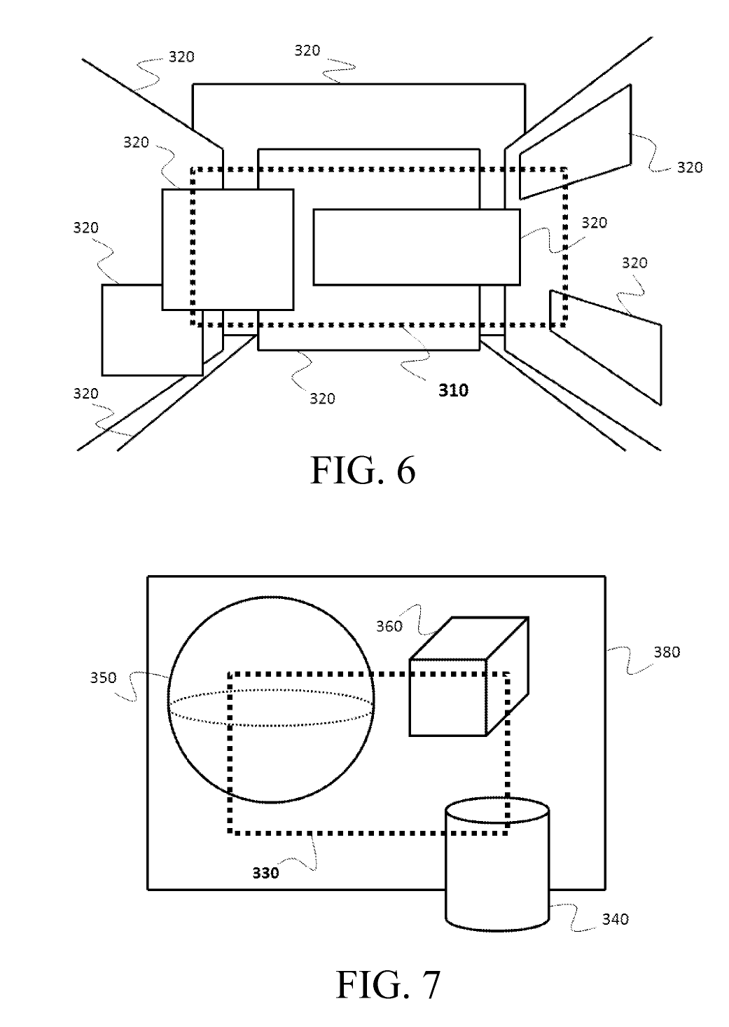

FIG. 5 illustrates a top view of another example presenting a point of view 210 where a head mounted projector is projecting a virtual screen 220 comprised of a first part 230, a second part 240, a third part 250, and a fourth part 260. The first part, the second part, the third part, and the fourth part of the virtual screen are successively projected on a first surface 270, a second surface 280, a third surface 290, and a fourth surface 300. Each of the first, second, third, and fourth surfaces are flat surface and located different positions. Taking into consideration the different position of each surface relative the point of view and adjusting the dimensions or shapes of the four parts of the virtual screen enables presenting the virtual screen to be viewed as a rectangular image from the point of view. The same technique is utilized in the example of FIG. 6 where a virtual screen 310 is projected on ten surfaces 320 that are located on different positions. The different positions of the ten surfaces are taken into consideration to reshape the ten parts of the virtual screen to be projected and seen as one rectangular window from the point of view.

The previous examples in FIGS. 1, 5, and 6 illustrate projecting a virtual screen on flat surfaces. FIG. 7 illustrates projecting a virtual screen on curved surfaces. As shown in the figure, a virtual screen 330 is projected on a cylinder 340, a sphere 350, a cube 360, and a vertical surface 370. The virtual screen is divided into six parts projected on the side surface and the top surface of the cylinder, the sphere surface, two faces of the cube, and the vertical surfaces. The position and curvature of the cylinder and sphere are taken into consideration to reshape the corresponding parts of the virtual screen projected on them. Also the position of the top surface of the sphere, the two faces of the cube, and the flat surface are taken into consideration to reshape the corresponding parts of the virtual screen projected on them. As a result, all parts of the virtual screen are projected to appear as one rectangular virtual screen relative to the point of view which creates the feeling of a two-dimensional image floating-in-midair in front of the user.

To create the feeling of a three-dimensional image floating-in-midair, the shape of the virtual screen is simultaneously altered with any change in the position of the point of view. Changing the position of the point of view may lead to changing the surfaces that the parts of the virtual screen are projected, measured by the head mounted projector's movement. Reshaping the virtual screen simultaneously with the movement of the point of view makes the virtual screen appear as if it has a fixed position, giving the sense of a 3D image floating-in-midair. Also the 3D effect of the virtual screen is greatly enhanced by presenting 3D objects inside the virtual screen where the parts or sides of the 3D object that appear to the user change with the change of the point of view during the user's movement. In this case, the user can move around the virtual screen and the 3D objects to see them from different points of view.

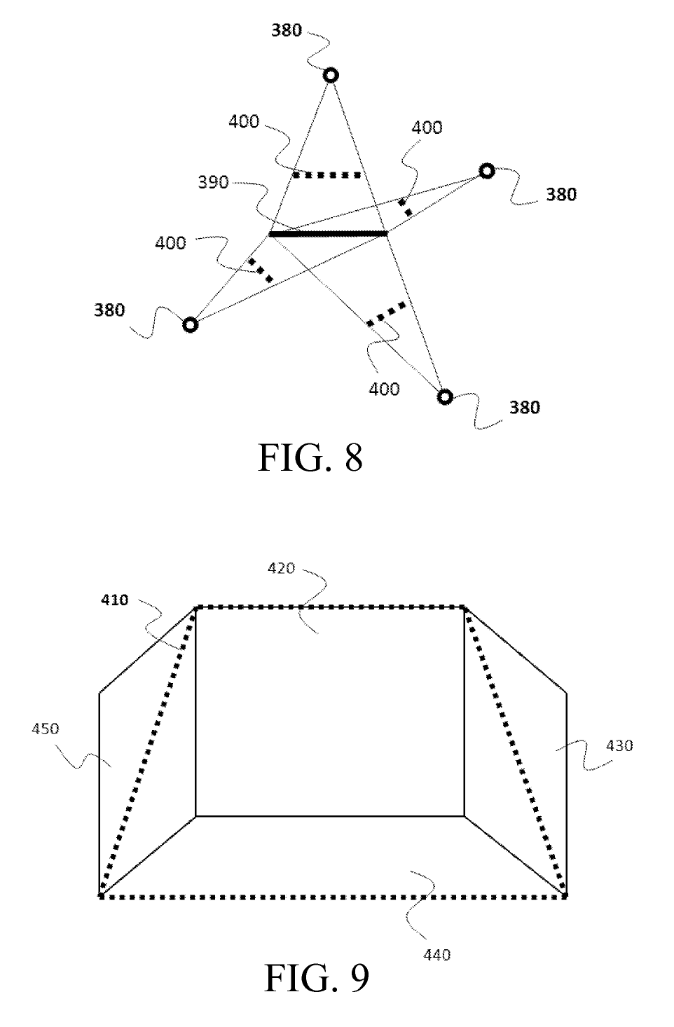

FIG. 8 illustrates a point of view 380 of a user moving while looking at a virtual screen 390 projected from a head mounted projector utilized by the user. At each new position of the point of view, the virtual screen changes its dimensions or shape to always appear as a rectangular window 400 that has a fixed position. Accordingly, the user can move around the virtual screen and see it from different points of view. For example, the virtual screen will appear bigger when the user moves closer to it, and the virtual screen will appear smaller when the user moves further from it. Also the virtual screen will appear to have a big width when the user stands perpendicular to its plane, and the virtual screen will appear to have a small width when the user stands parallel to its plane. In this case, the virtual screen will appear as a window floating-in-midair while the user is moving around this floating window and viewing it from different angles.

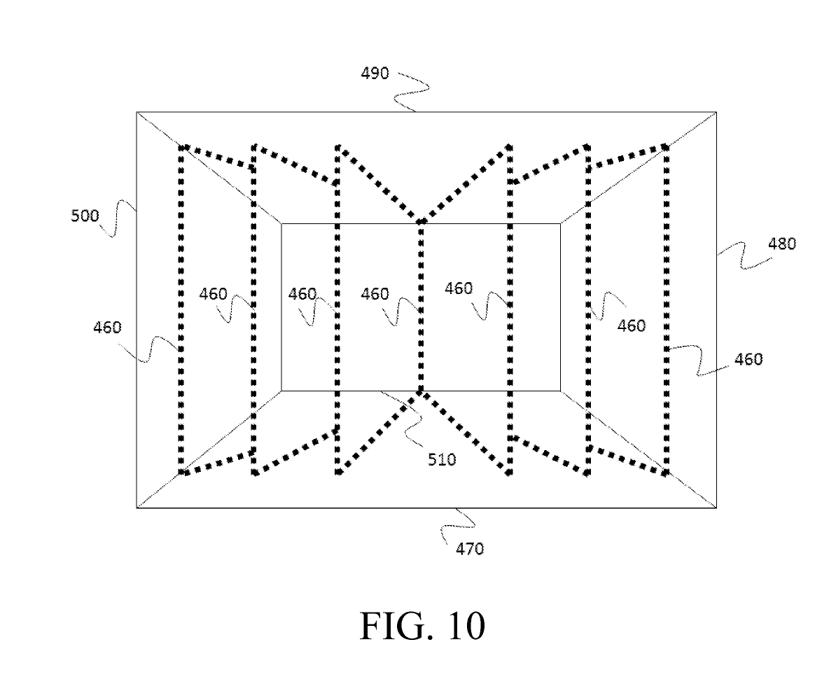

Generally, it is important to note that the virtual screen can take various shapes and forms and present different contents. For example, FIG. 9 illustrates a virtual screen 410 projected on four surfaces 420-450 appearing as a sloped virtual screen relative to a point of view. FIG. 10 illustrates a virtual screen 460 projected on five surfaces 470-510 to appearing as six pages of a book, where each page contains a different content. In all such cases, as will be described subsequently, the user can interact with the virtual screen or its contents. For example, in FIG. 10 the user can flip through the book pages of the virtual screen to view a specific page, or copy and paste content from a page to another.

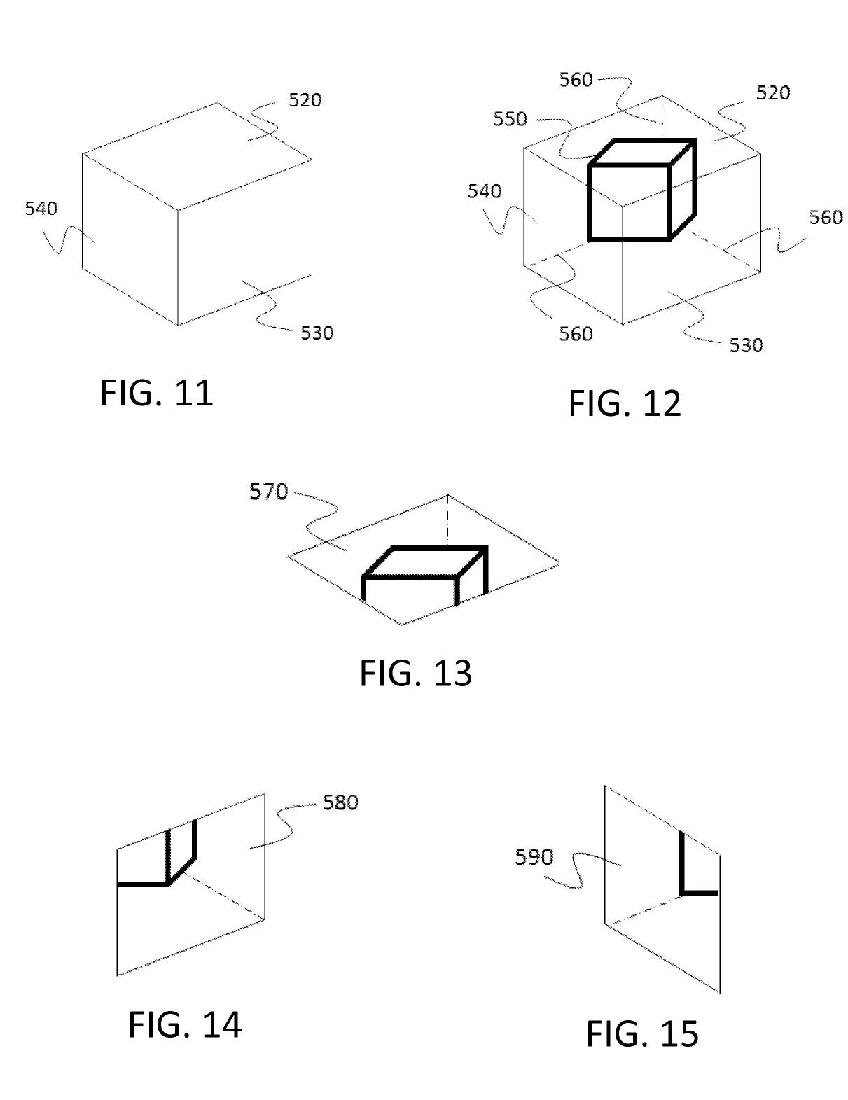

FIG. 11 illustrates a cube that has a first face 520, a second face 530, and a third face 540 located in front of a user where a virtual screen is projected on these three faces. FIG. 12 illustrates the virtual screen containing a virtual cube 550 and three dotted lines 560. As shown in the figure, projecting the virtual cube and the three dotted lines makes the virtual cube appear as if it is located inside the cube. FIG. 13 illustrates the first part 570 of the virtual screen projected on the first face of the cube. FIG. 14 illustrates the second part 580 of the virtual screen projected on the second face of the cube. FIG. 15 illustrates the third part 590 of the virtual screen projected on the third face of the cube. The three parts of the virtual screen are seen from the user's point of view as one virtual cube located inside the cube. If the user moved around the cube, the shape of the virtual cube and the three lines will be simultaneously changing to suit the new position of the user or the point of view. In this case, during the user's movement around the cube, the virtual screen will be projected on different faces of the cube according to the location of the point of view.

Generally, in all cases when a user moves around a virtual screen, different sides of the virtual screen appear to the user according to his/her position. For example, when a virtual screen is projected as a 2D floating window, the 2D floating window will have a front side and a back side that may present a different content of digital data. Moving around the 2D floating window enables seeing its front side or its back side according to the point of view during the user's movement. Also when a virtual screen is projected as a 3D cube, the user may see different faces of the cube during his/her movement around the cube. In this case also, each face of the cube may contain or present different content of digital data.

According to the previous description, in one embodiment, the present invention discloses a method for projecting an image on random surfaces from a movable projection source to make the image appear as a floating three-dimensional image relative to a point of view wherein the method is comprised of four steps. The first step is detecting the number, positions, and parameters of the random surfaces located in front of the movable projection source. The second step is dividing the image into parts wherein each part of the parts corresponds to a surface of the random surfaces. The third step is reforming each part according to the position and parameters of the corresponding surface to generate a reformed part wherein the reformed parts can be projected on random surfaces to appear as a floating three-dimensional image relative to the point of view. The fourth step is projecting the reformed parts from the movable projection source on to random surfaces.

In one embodiment, the parameters of the surface include the flatness or curvature of each surface. In another embodiment, the parameters of the surface also include the color or material of each surface to change the color or brightness of the correspond part of the virtual image. The number of the surfaces may vary from one surface to multiple surfaces according to the user's position and the nature of the surrounding environment. In some cases, when the image is projected on natural surfaces, such as a mountain surface, each point of the mountain is considered as a surface, and accordingly, the number of surfaces will be a big number. In this case, the image is divided into a number of spots equal to the number of the mountain points in front of the image projection where each spot is corresponding to one point of the mountain surface.

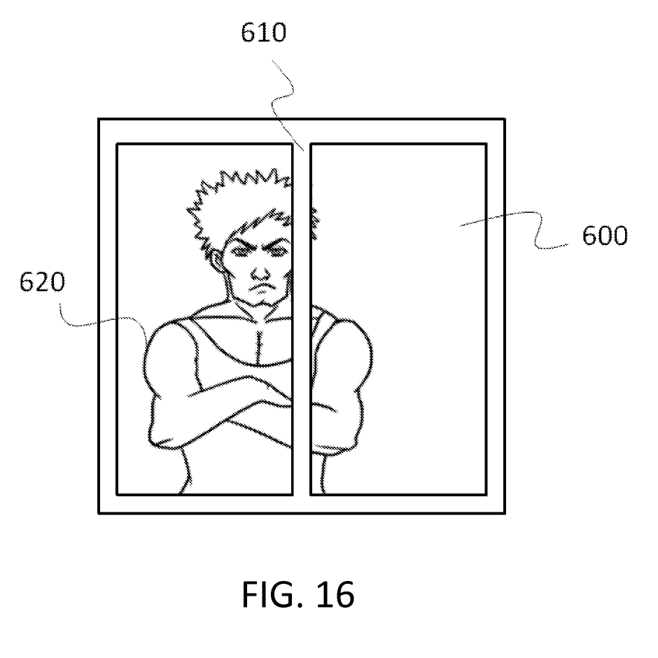

In one embodiment of the present invention, hiding parts of the image of the virtual screen before projecting it enhances the effect of the third dimensions. For example, FIG. 16 illustrates a transparent glass 600 window with some opaque parts 610 where a virtual screen is projected on this window to present an image of a person standing behind the window. As shown in the figure, some parts of the person's image are hidden to make the person image appears as s/he is standing behind the window. These hidden parts are the parts of the virtual screen that are corresponding to the opaque parts in the middle of the window. Generally, this type of application depends mainly on identifying the parameters of the objects or surfaces located in front of the point of view. For example, identifying which parts of the window are glasses and which parts are not glasses, in addition to, identifying the window from other objects located in front of the user.

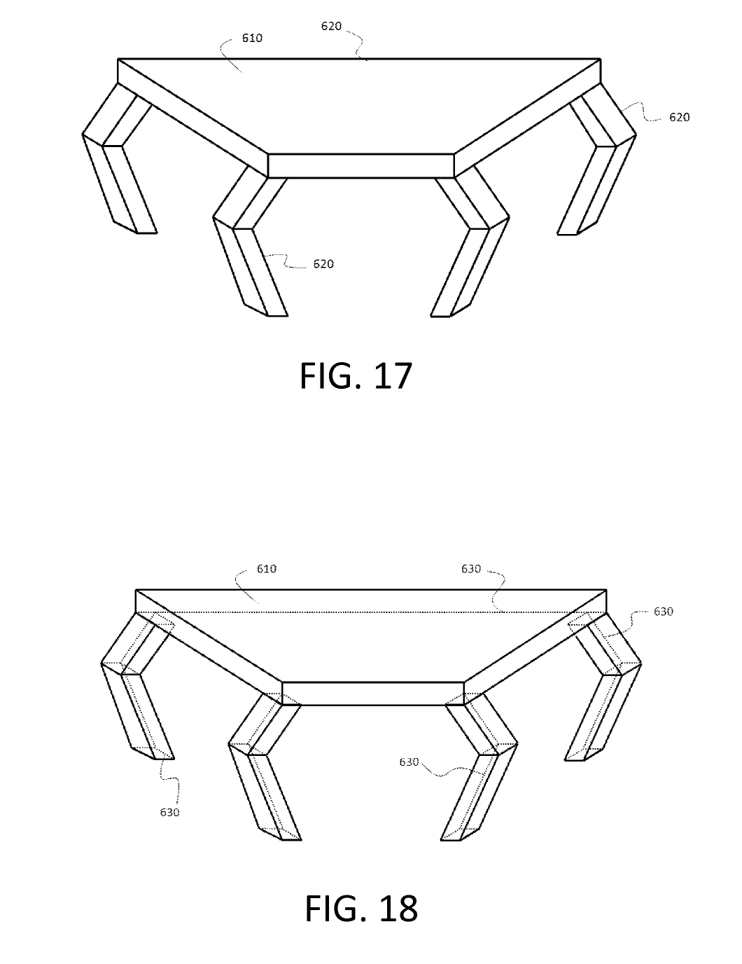

FIG. 17 illustrates a table 610 that automatically identifies to a user where the lines 620 represent the edges of this table. FIG. 18 illustrates projecting a virtual screen on this identified table containing dotted lines 630 representing the hidden edges of this table. In this case, the dotted lines have fixed positions related to the table parts where the movement of the point of view does not change the position of the dotted lines. In other words, the projection of the dotted lines will target the table regardless of the movement of the projector. This is achieved by adjusting the location of the dotted lines in the projected image to be always located on the table. In other words, the identity and location of the table are taken into consideration and the position of the dotted lines in the image are adjusted to be accurate projections on the corresponding parts of the table.

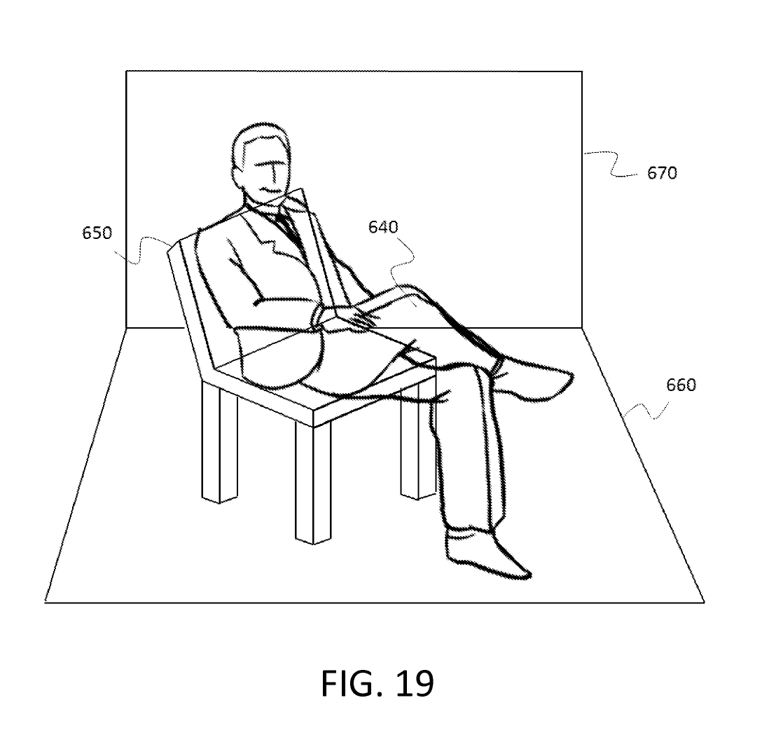

FIG. 19 illustrates projecting a virtual screen which presents a person's image 640 on a chair 650, a floor 660, and a wall 670. The person's image is created and projected to present a person sitting on the chair relative to a point of view. As shown in the figure, the person's image is divided into a first part projected on chair, a second part projected on the floor, and a third part projected on the wall. The first part of the person's image that is projected on the chair is also divided into multiple parts projected on multiple surfaces of the chair. Generally, in this example, when the position of the point of view changes with the user's movement then the first, second, and third parts of the person's image simultaneously change to make the person appears as if s/he is sitting on the chair regardless of the user's movement or point of view.

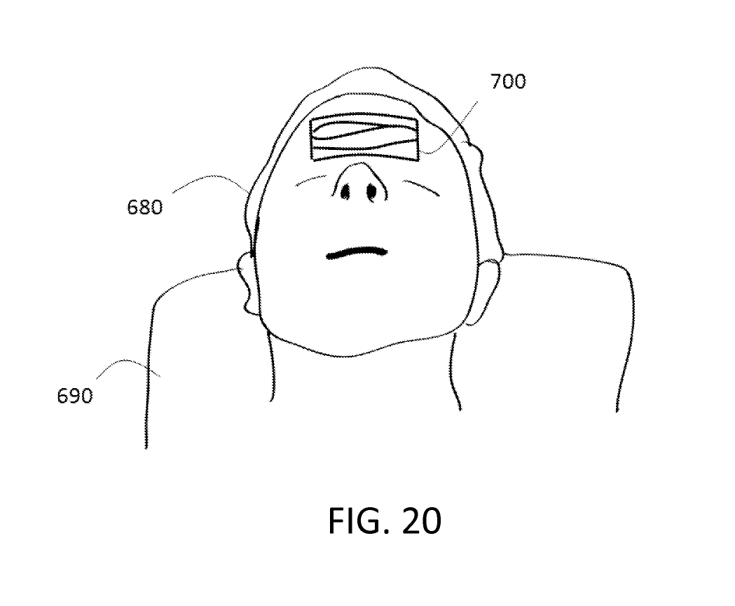

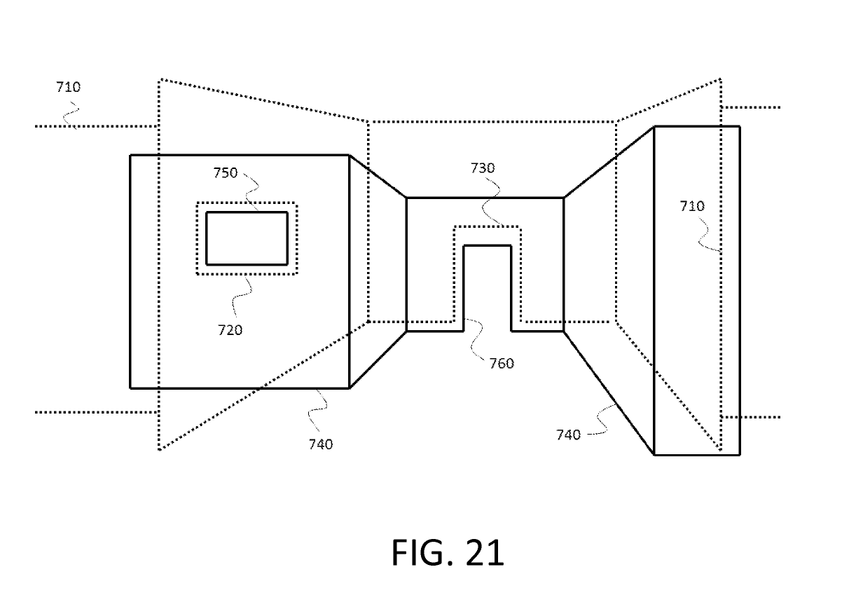

FIG. 20 illustrates a medical application for the present invention where a person 680 is sleeping on a pillow 690 while a virtual screen 700 is projected on the person's forehead presenting a 3D medical image for the person's brain. The 3D medical image is displayed according to the point of view of a user or physician who is utilizing the head mounted projector that projects the 3D medical image. Once the physician moves his/her head to view another part of the person's body then the head mounted projector projects the corresponding 3D medical image of the body part that the physician is looking at.

FIG. 21 illustrates another example for an augmented reality application where the dotted lines in the drawing represent a part of a building comprised of real walls 710, a real window 720, and real door 730. The solid lines in the drawing represent a virtual 3D home projected in a virtual screen on the building. The virtual 3D home includes virtual walls 740, a virtual window 750, and virtual door 760. In this example, the identity of the real walls, real window, and real door of the building are taken into consideration to project the virtual window on the real window and the virtual door on the real door with regard to the movement of the user's point of view.

Generally, the virtual 3D home can be big enough to completely cover a building. In such cases, the virtual windows and doors of the virtual 3D model will be created to be aligned and projected on the real doors or windows of the building. This way, the user can walk through the virtual 3D home using the virtual doors that are located on top of real doors openings. Also the user can look through the virtual windows that are located on top of the real windows openings to see the outside of the building. In fact, such utilization of the present invention converts the augmented reality application from displaying the virtual objects on a screen of a tablet or a computer to displaying the virtual objects on a surrounding environment or buildings.

According to the previous description, in another embodiment, the present invention discloses a method for projecting a virtual 3D model on a 3D environment wherein certain virtual objects of the virtual 3D model are projected on certain actual objects of the 3D environment while the source of the virtual 3D model is moving and the method comprising of five step. The first step is identifying the virtual objects. The second step is identifying the certain actual objects located in front of the source of projection. The third step is determining the momentary location of certain actual objects relative to the projection source. The fourth step is changing the position and dimensions of certain virtual objects in the virtual 3D model according to the location of the certain actual objects to make the certain virtual objects projected on top of the certain actual objects. The fifth step is projecting the image of the virtual 3D model on the 3D environment during the movement of the source of projection.

In one embodiment, the 3D environment is the environment that surrounds the user, whether indoor or outdoor. The projection source is a head mounted projector utilized by the user while s/he is walking through the 3D environment. The identification of the virtual objects is manually achieved by associating an ID for each virtual object of the 3D model, or the identification of the virtual objects is automatically achieved by using a computer vision program for 3D models as known in the art. The identification of the actual objects is also automatically achieved by using a computer vision program that analyzes the image of the actual objects located in front of the head mounted projector. The determination of the location of the certain actual objects relative to the projection source is achieved by using a depth sensing camera or a 3D laser scanner.

Generally, the main advantage of the present invention is utilizing an existing hardware technology that is simple and straightforward which easily and inexpensively carries out the present method of creating and projecting floating 3D image in midair.

For example, the locations and shapes of the surfaces located in front of the point of view can be detected using different techniques. In one embodiment of the present invention, the locations and shapes of the surfaces located in front of the point of view are obtained from a database that stores a 3D model for the surrounding environment or surfaces located around the user. This includes the walls, doors, windows, furniture, equipment, or the like. In this case the database stores the 3D model of each object with its dimensions and location, in addition to, the ID of the object which is utilized in projecting certain virtual objects on certain real objects as was described previously.

In another embodiment, the surfaces located in front of the point of view are scanned by a 3D scanner that analyzes the surfaces in a random direction to collect data on the surfaces position, shape, and appearance including color. The 3D scanner captures the image of the surface in its field of view where the picture produced by the 3D scanner describes the distance to the surfaces at each point in the picture. This allows the three dimensional position of each point in the picture relative to the position of the 3D scanner to be identified. In one embodiment, the 3D scanner is an active scanner that emits a kind of radiation or light and detects its reflection in order to probe the surfaces in front of the 3D scanner after steering the 3D scanner to the random direction.

The advantage of using the 3D scanner over the database is that the locations of the surfaces located in front of the user will be related to the position of the point of view, based on positioning the 3D scanner near the user's eye. When utilizing a database, the user's position is detected in real time using a position detection tool. The position detection tool will then detect the position and direction of the user's eyes using a 3D accelerometer, compass, and GPS as known in the art.

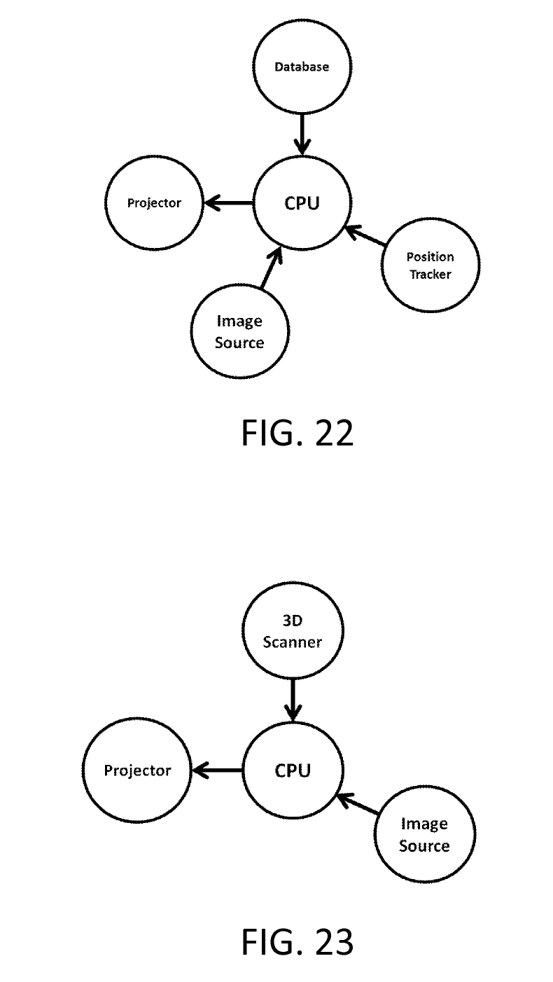

In both cases, using a database or a 3D scanner, a CPU is utilized to retrieve the data of the surfaces from the database or the 3D scanner to reform the projected image according to this data. FIG. 22 illustrates a block diagram connecting the CPU with the database while a projector, image source, and position tracker are utilized with the CPU. The image source contains the data of the image before reforming it according to the surfaces located in front of the point of view. The position tracker is the tool that tracks the location and direction of the user's eye. FIG. 23 illustrates the main components of the present invention when replacing the database with a 3D scanner where the CPU is connected with a projector, a 3D scanner, and an image source. In this case, there is no need for the position tracker as was described previously.

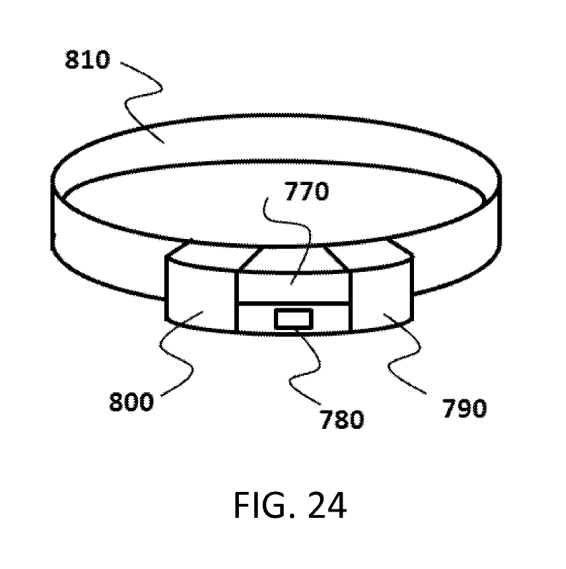

According to one embodiment of the present invention, FIG. 24 illustrates a device comprised of a 3D scanner 770, a projector 780, a CPU 790, and a memory unit 800 installed on a cylindrical strip 810 that can be attached to the user's head. The memory unit stores the data of the virtual screen which might include 3D models, images, videos, text, or the like. Having the strip attached to the user's forehead makes the position of the projector and the user's eyes, or point of view, very similar to each other.

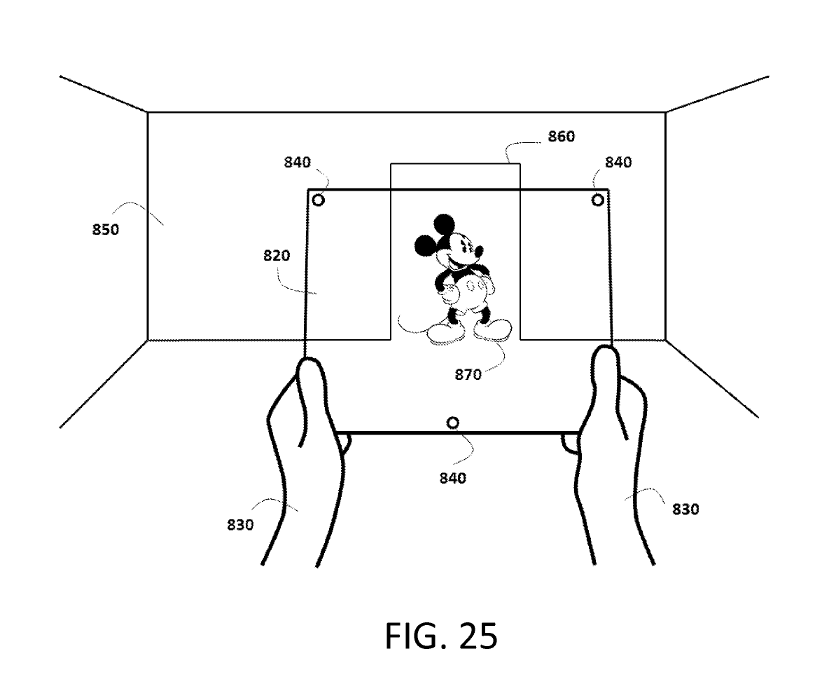

In one embodiment of the present invention, the projection of the virtual screen on the surfaces located in front of the point of view is replaced with a projection on a transparent surface held by the user's hands. For example, FIG. 25 illustrates a transparent surface 820 held by a user's hands 830 where three markers 840 are located on the transparent surface. As shown in the figure, the user is seeing a wall 850 and a door opening 860 through the transparent surfaces. The virtual screen projected on the transparent surface presents a 3D model of Mickey Mouse 870 at the door opening. In this case, a camera is utilized to track the three markers in order to detect the location and tilting of the transparent surface in the user's hands. The 3D scanner scans the surfaces located in front of the point of view and the projector projects the virtual screen on the transparent surface to suit the surfaces located behind the transparent surfaces.

As shown in the figure, the 3D model of Mickey Mouse is projected to appear as if it is located at the door opening. Moving or tilting the transparent surface will change the content of the virtual screen to always make Mickey Mouse consistently appear at the door opening relative to the point of view. For example, if the transparent surface is moved to the right, then the virtual screen will move Mickey Mouse to the left to appear at the door opening. Also, if the transparent surface is titled vertically or horizontally then the virtual screen will change the dimensions of Mickey Mouse to make him appear as if he was not affected by the tilting of the transparent surface. If the transparent surface is moved away or closer from/to the user then the image of Mickey Mouse will be resized to look as if he was not affected by the movement of the transparent surface.

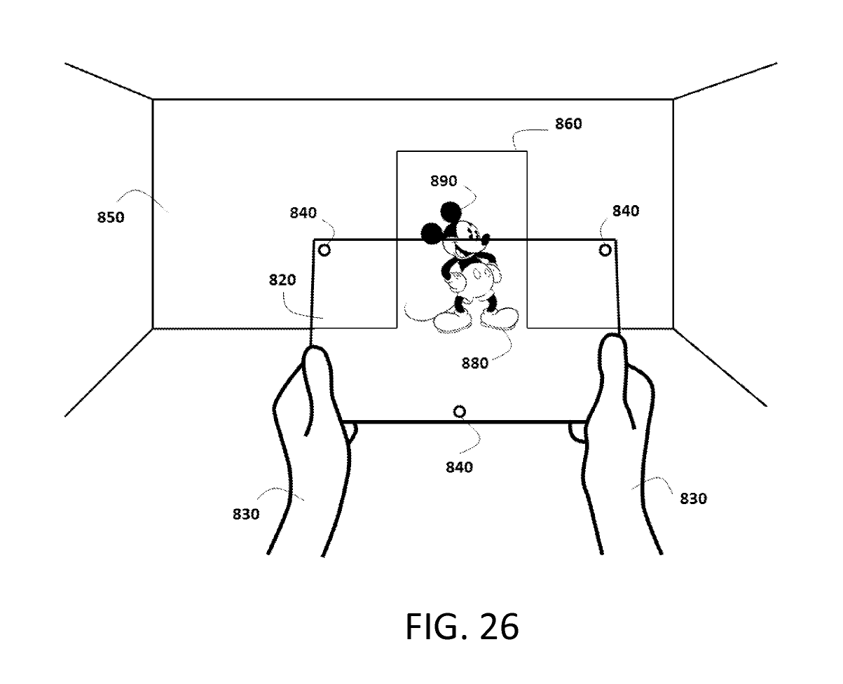

In another embodiment of the present invention, the virtual screen is simultaneously projected on both the transparent surface and the surfaces located in front of the point of view. For example, FIG. 26 illustrates dividing the image of Mickey Mouse into a first part 880 projected on the wall located behind the transparent surface, and a second part 890 projected on the transparent surface. If the transparent surface is completely moved away from the door then the image of Mickey Mouse will be projected on the wall. If the transparent surface completely covers the door then the image of Mickey Mouse will be completely projected on the transparent surface. This way, Mickey Mouse appears to the user as a real person standing in front of the door, regardless of the movement of the transparent surface

According to the previous description, in one embodiment the present invention discloses a method for projecting an image on a transparent surface that can be held by a user's hands wherein the content of the image suits the identity of the objects located behind the transparent surface relative to a point of view, and the method comprising four steps. The first step is detecting the identity of the objects located behind the transparent surface. The second step is detecting the movement of the transparent surface. The third step is changing the position of the content according to the identity of the objects and the movement of the transparent surface to make certain contents appear on top of certain objects when the image is projected on the transparent surface. The fourth step is projecting the image on the transparent surface.

The idea of projecting the virtual screen on a transparent surface can be replaced with projecting the virtual screen directly on a user's retina, head mounted display, eye glasses, or the like. In all such cases, the user's hands are free so they can be moved to provide an immediate computer input to a computer system, enabling interaction with the content of the virtual screen as was described previously.

One of the innovative applications of the present invention is hiding real objects in front of a user. This is achieved by projecting the scene behind the object on the object surfaces to give the illusion of disappearing the object and appearing the scene to the user. In this case, it is required to capture the scene behind the user then project this scene on the object after reforming the scene image according to the surfaces of the object. The same process can be utilized to project the scene behind the object on the user's retina to make the object disappear in front of the user. In this case the scene image will not be reformed since it will not be projected on the object surfaces.

As mentioned previously, the user can interact with the content of the virtual screen similar to interacting with content presented on a computer display. This is achieved by using a camera that tracks the movements of the user's hands or fingers and a software program is utilized to interpret these movements into an input to a computer system. It is also possible to replace the camera with any other tracking tools or systems, such as optical sensors, laser sensors, or the like.

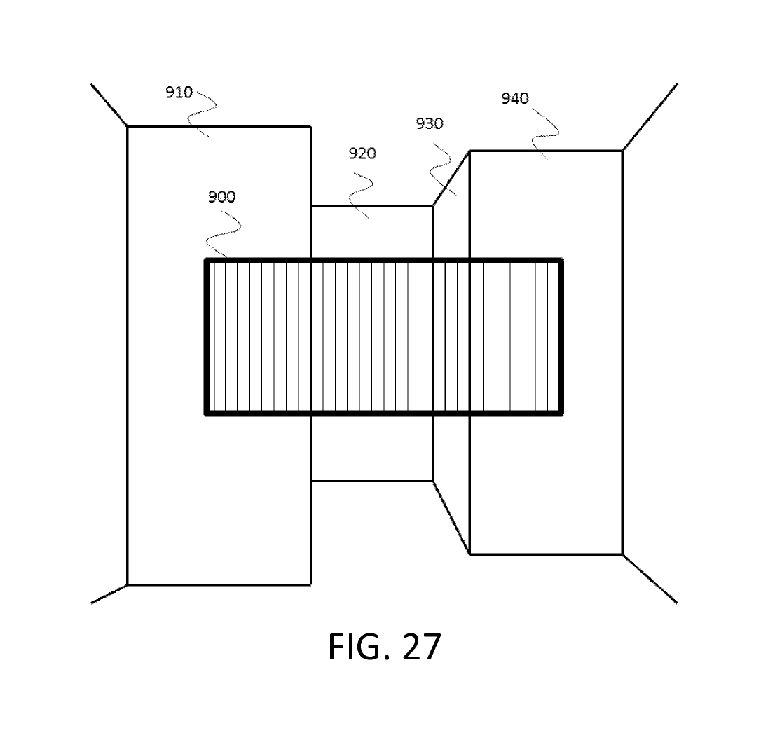

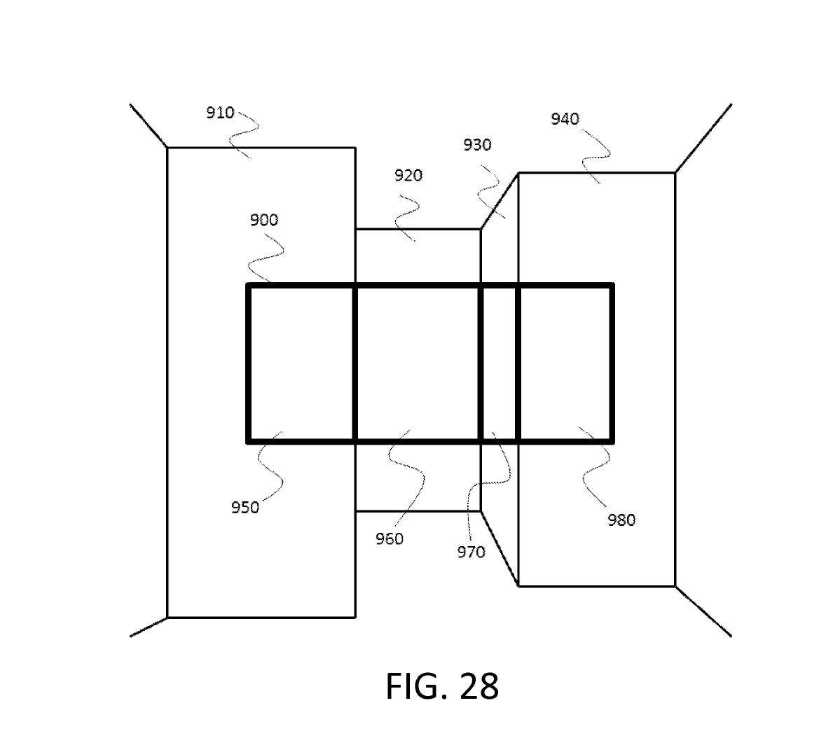

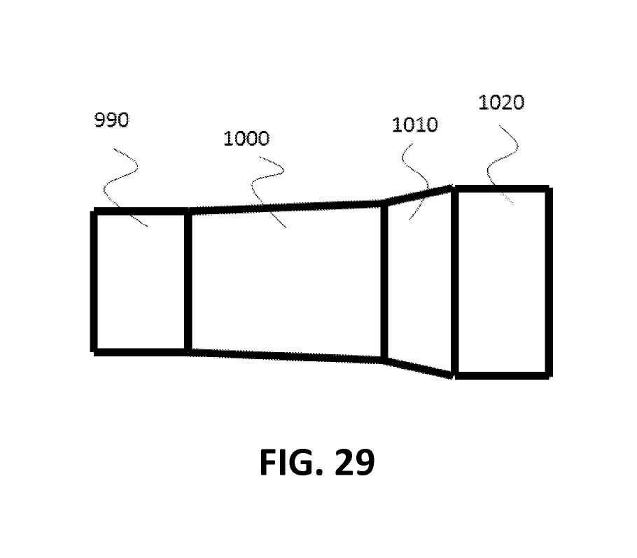

Finally, to clarify the idea of reforming the image of the virtual screen according to the point of view and the surfaces located in front of the projector. FIG. 27 illustrates a virtual screen 900 projected on a first wall 910, a second wall 920, a third wall 930, and a fourth wall 940. According to the point of view, FIG. 28 illustrates a first part 950, a second part 960, a third part 970, and a fourth part 980 of the virtual screen, successively projected on the first wall, second wall, third wall, and fourth wall. FIG. 29 illustrates the real shape or projection of the four parts on the four walls. As shown in the figure, the real projections of the first part 990, second part 1000, third part 1010, and fourth part 1020 of the virtual screen appear different from what appears to the point of view in FIG. 28.

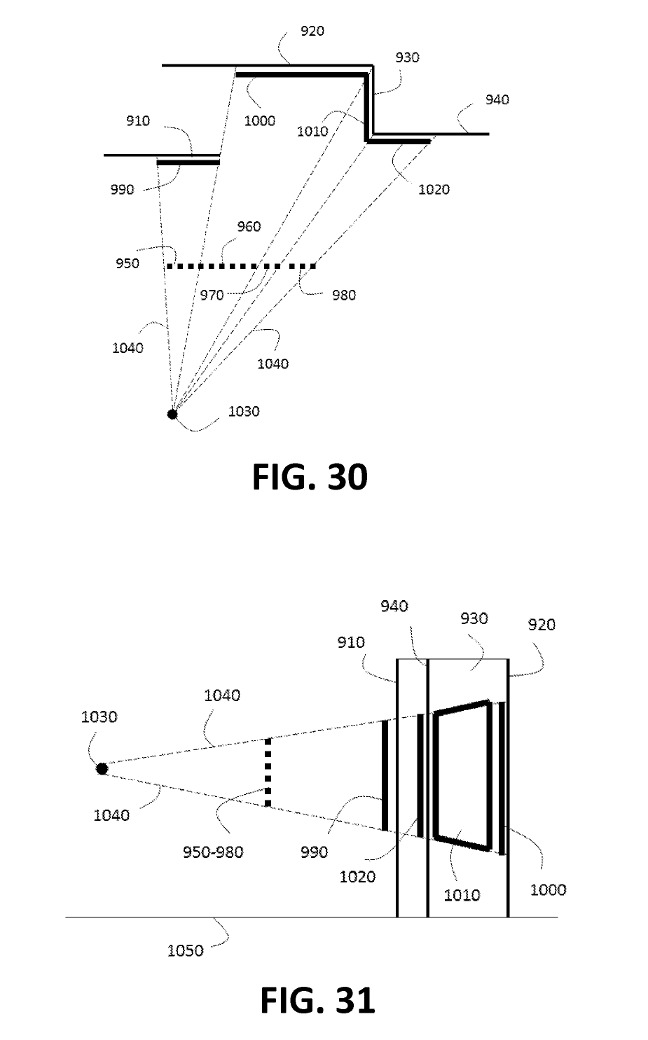

To explain the mathematical process for creating the four parts of the real projection of the virtual screen, FIG. 30 illustrates a top view presenting the first, second, third, and fourth walls 910-940, the first, second, third, and fourth parts 950-980 of the virtual screen, and the first, second, third, and fourth real projections 990-1020 of the virtual screen. The point of view 1030 appears in this top view where the projection rays 1040 extend from the projector at the position of the point of view to the four walls. FIG. 31 illustrates a side view presenting the four walls, the four parts of the virtual screen, the four real projections of the virtual screen, the point of view, and the projection rays. The horizontal line 1050 in the figure represents the ground line or level. Generally, mathematically combining the lines representing the four projection parts in the top view with the line representing the four projections parts in the side view generates the real projections of the virtual screen of FIG. 29.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A method for projecting an image on random surfaces from a movable projection source to make the image appears as a floating three-dimensional image relative to a point of view wherein the method comprising:
detecting the number, positions, and slopes of the random surfaces located in front of the movable projection source;
dividing the image into parts wherein each part of the parts corresponds to a surface of the random surfaces;
reforming each part according to the position and parameters of the corresponding surface to generate a reformed part wherein the reformed parts can be projected on the random surfaces to appear as a floating three-dimensional image relative to the point of view; and
projecting the reformed parts from the movable projection source on the random surfaces.

2. The method of claim 1 wherein said movable projection source is a head mounted projector that can be attached to a forehead of a user.

3. The method of claim 1 wherein said point of view is located at the position of a user's eyes.

4. The method of claim 1 wherein said detecting is achieved by a 3D scanner that detects the distance between each point of said random surface and said point of view.

5. The method of claim 1 wherein said detecting is achieved by a position tracking tool for said point of view connected a database that stores a 3D model for said random surfaces to retrieve said number, positions, and slopes according to said position of said point of view.

6. The method of claim 1 wherein said slope represents a flat surface or represent a curved surface.

7. The method of claim 1 wherein said reforming includes changing the dimensions, shape, or content of each part to be projected to appear to said point of view similar to said each part before said reforming.

8. The method of claim 1 wherein said image appears in front of said point of view while said movable projection source and said point of view are moving.

9. The method of claim 1 wherein said image appears to said point of view at a fixed location regardless of the movement of said movable projection source or the movement of said point of view.

10. The method of claim 1 wherein said slope represents a flat surface or a curved surface.

11. The method of claim 1 wherein said image contains 3D objects can be viewed from different positions according to said point of view.

12. The method of claim 1 wherein the movement of a user's hands or fingers is tracked to represent an immediate input to a computer system for interacting with the content of said image.

13. A method for projecting a virtual 3D model on a 3D environment wherein certain virtual objects of the virtual 3D model are projected on certain actual objects of the 3D environment while the source of projecting the virtual 3D model is moving and the method comprising:
identifying the virtual objects;
identifying the certain actual objects when located in front of the source of projection;
determining the momentary location of certain actual objects relative to the projection source;
changing the position and dimensions of the certain virtual objects in the virtual 3D model according to the location of the certain actual objects to make the certain virtual objects projected on top of the certain actual objects; and
projecting the image of the virtual 3D model on the 3D environment during the movement of the source of projection.

14. The method of claim 13 wherein said virtual 3D model represents a 3D model of a virtual building, said 3D environment represents an actual building, said certain virtual objects are virtual doors and virtual windows, and said actual objects are doors and windows in said actual building.

15. The method of claim 13 wherein said source of projection is a head mounted projector that can be attached to the forehead of a user.

16. The method of claim 13 wherein said identifying of said virtual objects is achieved manually by associating an ID to each one of said virtual objects.

17. The method of claim 13 wherein said identifying of said virtual objects is achieved automatically using a recognition program for 3D models.

18. The method of claim 13 wherein said identifying of said actual objects is achieved automatically using a computer vision program for object recognition that analyzes the image of said actual objects.

19. The method of claim 13 wherein said identifying of said actual objects is achieved by a database that stores a 3D model of said 3D environment whereas each one of said actual objects is associated with an identifier in said database.

20. The method of claim 13 wherein said determining of said momentary location is achieved by utilizing a 3D scanner located at the position of said projection source.

21. The method of claim 13 wherein said virtual 3D model are projected on a user's retina located on top of said certain actual objects relative to the user.

22. A method for projecting an image on a transparent surface that can be held by a user's hands wherein the content of the image suits the identity of the objects located behind the transparent surface relative to a point of view, and the method comprising;
detecting the identity of the objects located behind the transparent surface;
detecting the movement of the transparent surface;
changing the position of the content according to the identity of the objects and the movement of the transparent surface to make certain contents appear on top of certain objects when the image is projected on the transparent surface; and
projecting the image on the transparent surface.

23. The method of claim 21 wherein said detecting of the identity is achieved by utilizing a computer vision program for object recognition that analyzes the image of said actual objects.

24. The method of claim 21 wherein said detecting of the identity is achieved by a database that stores a 3D model of said objects whereas each one of said objects is associated with an identifier in said database.

25. The method of claim 21 wherein said detecting the movement is achieved by utilizing markers in said transparent surface where a camera tracks the movement of said markers.

26. The method of claim 21 wherein said image is simultaneously projected on said transparent surface and the surfaces or objects located behind said transparent surface.

27. The method of claim 21 wherein said transparent surface can be moved, rotated, or titled by a user's hands.

28. The method of claim 21 wherein projection is achieved by a head mounted projector that can be attached to a forehead of a user.

29. The method of claim 21 wherein said point of view is located at the position of a user's eyes.

30. The method of claim 21 wherein said point of view and said transparent surface can be moved simultaneously.

31. The method of claim 21 wherein one or more objects of said content appear to said point of view at a fixed location regardless of the movement of said transparent surface or the movement of said point of view.

32. The method of claim 21 wherein said transparent surface is a user's retina and said image is projected on said user's retina.
